(19) United States
(12) Patent Application Publication
(10) Pub. No.: US 2012/0050219 A1
(43) Pub. Date: Mar. 1, 2012

(54) CAPACITIVE TOUCH APPARATUS, TOUCH DISPLAY, AND DRIVING METHOD THEREOF

(75) Inventors: Kuo-Sheng LEE, Tainan City (TW); Chun-Hsi CHEN, Tainan City (TW); Chi-Hung YEH, Tainan City (TW)

(73) Assignee: CHIMEI INNOLUX CORPORATION, Chu-Nan (TW)

(21) Appl. No.: 13/187,770

(22) Filed: Jul. 21, 2011

(30) Foreign Application Priority Data
Aug. 31, 2010 (TW) 099129356

(51) Int. Cl. G06F 3/044

(52) U.S. Cl. 345/174

(57) ABSTRACT

A capacitive touch apparatus, a touch display and a driving method thereof are provided. The capacitive touch apparatus comprises a plurality of electrodes and a plurality of integrators. The electrodes are respectively coupled to the integrators. Each integrator comprises an operational amplifier, a capacitor and a switch. The operational amplifier receives a reference voltage, which changes to a second level from a first level in a reset interval and changes to the first level from the second level in a sense interval which comes before the reset interval. The capacitor and the switch are coupled to the operational amplifier. The switch is turned on in the reset interval for connecting both terminals of the capacitor and is turned off in the sense interval.

This application claims the benefit of Taiwan application Serial No. 99129356, filed Aug. 31, 2010, the subject matter of which is incorporated herein by reference.

### BACKGROUND OF THE INVENTION

1. Field of the Invention

The invention relates in general to a touch apparatus, and more particularly to a capacitive touch apparatus, a touch display and a driving method thereof.

2. Description of the Related Art

Currently, the touch panel can be divided into resistive touch panel and capacitive touch panel. The resistive system comprises a standard glass panel covered by a conductive layer and a resistive metal layer, wherein the two layers are divided by a spacer for allowing the current to flow between the two layers. Lastly, an anti-scratch layer is further disposed thereon. When the user touch the screen, the conductive layer and the resistive metal layer comes into touch, the change in the electrical field is recorded as a touch event, and subsequent signal processing is performed.

The capacitive system adapts a capacitive sensor. When the user touches the screen to allow continuous current flows through the sensor, so that the sensor can precisely store electrons in the horizontal and the vertical directions to form a precisely controlled capacitance field. When the normal capacitance field of the sensor is changed by another capacitance field (that is, when the finger touches different positions), the circuit at each corner of the panel calculates the change in the electric field and performs subsequent processing on the touch event signal.

Referring to FIG. 1, a first type of conventional capacitive touch apparatus is shown. The first type of conventional capacitive touch apparatus 10 comprises a controller 110, a sensing integrated circuit 120, a sensing integrated circuit 130, row electrodes 140(1)˜140(m), column electrodes 150(1)˜150(n), row electrodes 160(1)˜160(m), column electrodes 170(1)˜170(n) and a substrate 180. The controller 110 controls the sensing integrated circuit 120 and the sensing integrated circuit 130. The sensing integrated circuit 120 sequentially scans the row electrodes 140(1)˜140(m) and the column electrodes 150(1)˜150(n). The sensing integrated circuit 130 sequentially scans the row electrodes 160(1)˜160(m) and the column electrodes 170(1)˜170(n). The substrate 180 comprises a left half 182 and a right half 184. The row electrodes 140(1)˜140(m) and the column electrodes 150(1)˜150(n) are disposed on the left half 182. The row electrodes 160(1)˜160(m) and the column electrodes 170(1)˜170(n) are disposed on the right half 184.

Referring to FIG. 2, a second type of conventional capacitive touch apparatus is shown. The second type of conventional capacitive touch apparatus 20 comprises a controller 210, a sensing integrated circuit 220, a sensing integrated circuit 230, row electrodes 240(1)˜240(m), and column electrodes 250(1)˜250(n). The controller 210 controls the sensing integrated circuit 220 and the sensing integrated circuit 230. The sensing integrated circuit 220 sequentially scans the row electrodes 240(1)˜240(m). The sensing integrated circuit 230 sequentially scans the column electrodes 250(1)˜250(n). The row electrodes 240(1)˜240(m) and the column electrodes 250(1)˜250(n) are interlaced.

Referring to FIG. 3 and FIG. 4. FIG. 3 shows an equivalent circuit diagram when a capacitive touch apparatus is touched. FIG. 4 shows the voltage difference between the two terminals of an equivalent capacitor varying with the time. When the user touches the capacitive touch apparatus, an additional capacitor Cf is connected in parallel with the capacitor Cp disposed between the row electrodes and the column electrodes. In other words, when the user touches the capacitive touch apparatus, the equivalent capacitor C=Cf+Cp. The constant current source 310 generates a current I for charging the equivalent capacitor C. The operational amplifier 320 determines whether the voltage V difference between the two terminals of the equivalent capacitor C is larger than the threshold voltage V_{TH}. Whether the user touches the capacitive touch apparatus is determined according to the occurrence that the voltage V is larger than the threshold voltage V_{TH}.

Due to the long resistive-capacitive delay (RC-Delay), the panel size of the conventional touch panel cannot be increased. In addition, since the conventional touch panel needs to sequentially scan all electrodes, the scan time will be insufficient if the panel size is too large or the resolution level is too high, which implies that more electrodes need to be scanned.

### SUMMARY OF THE INVENTION

The invention is directed to a capacitive touch apparatus, a touch display and a driving method thereof. The method detects the transfer amount of charges rather than the resistive-capacitive delay (RC-delay), and further eliminates the influence resulted by the parasitic capacitance, so that the capacitive touch apparatus can be used in large-scaled touch panel. In addition, the capacitive touch apparatus does not scan all electrodes sequentially, hence avoiding the problem of insufficient scan time.

According to a first aspect of the present invention, a capacitive touch apparatus is provided. The capacitive touch apparatus comprises a plurality of electrodes and a plurality of integrators. The electrodes are respectively coupled to the integrators. Each integrator comprises an operational amplifier, a capacitor and a switch. The operational amplifier receives a reference voltage, which changes to a second level from a first level in a reset interval and changes to the first level from the second level in a sense interval which comes before the reset interval. The capacitor and the switch are coupled to the operational amplifier. The switch is turned on in the reset interval for connecting both terminals of the capacitor and is turned off in the sense interval.

According to a second aspect of the present invention, a driving method of capacitive touch apparatus is provided. The capacitive touch apparatus comprises a plurality of electrodes and a plurality of integrators. The electrodes are respectively coupled to the integrators. Each integrator comprises an operational amplifier, a capacitor and a switch. The driving method comprises the steps of turning on the switch for connecting both terminals of the capacitor in the reset interval and changing the reference voltage to a second level from a first level; and turning off the switch in the sense interval and changing the reference voltage to the first level from the second level.

According to a third aspect of the present invention, a touch display is provided. The touch display comprises a capacitive touch apparatus and a display layer. The capacitive touch apparatus comprises a touch layer and a plurality of integrators. The touch layer comprises a plurality of electrodes disposed above the display layer and respectively coupled to a plurality of integrators. Each integrator comprises an operational amplifier, a capacitor and a switch. The operational amplifier receives a reference voltage, which changes to a second level from a first level in a reset interval and changes to the first level from the second level in a sense interval which comes before the reset interval. The capacitor and the switch are coupled to the operational amplifier. The switch is turned on in the reset interval for short-circuiting the capacitor and is turned off in the sense interval.

According to a fourth aspect of the present invention, a driving method of touch display is provided. The touch display comprises a capacitive touch apparatus and a display layer. The capacitive touch apparatus comprises a plurality of electrodes and a plurality of integrators. The electrodes are respectively coupled to the integrators and disposed above the display layer. Each integrator comprises an operational amplifier, a capacitor and a switch. The driving method comprises the steps of turning on the switch for connecting both terminals of the capacitor in the reset interval, and changing the reference voltage to a second level from a first level; and turning off the switch and changing the reference voltage to the first level from the second level in the sense interval.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 shows a first type of conventional capacitive touch apparatus;

FIG. 2 shows a second type of conventional capacitive touch apparatus;

FIG. 3 shows an equivalent circuit diagram when a capacitive touch apparatus is touched;

FIG. 4 shows the voltage difference between the two terminals of an equivalent capacitor varying with the time;

FIG. 5 shows a touch layer and a display layer;

FIG. 6 shows a capacitive touch apparatus;

FIG. 7 shows a timing sequence of a capacitive touch apparatus;

FIG. 8 shows a capacitive touch apparatus having 1×1 resolution level and not being touched;

FIG. 9 shows an equivalent circuit diagram of FIG. 8;

FIG. 10 shows a capacitive touch apparatus having 1×1 resolution level and the column electrode x is being touched;

FIG. 11 shows an equivalent circuit diagram of FIG. 10; and

FIG. 12 shows a flowchart of a driving method according to an embodiment of the invention.

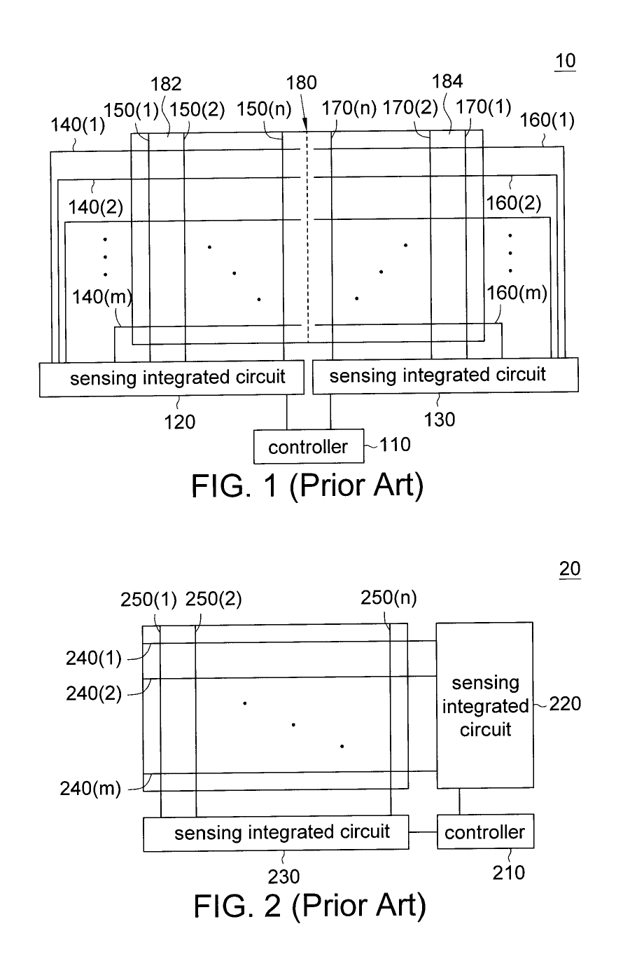

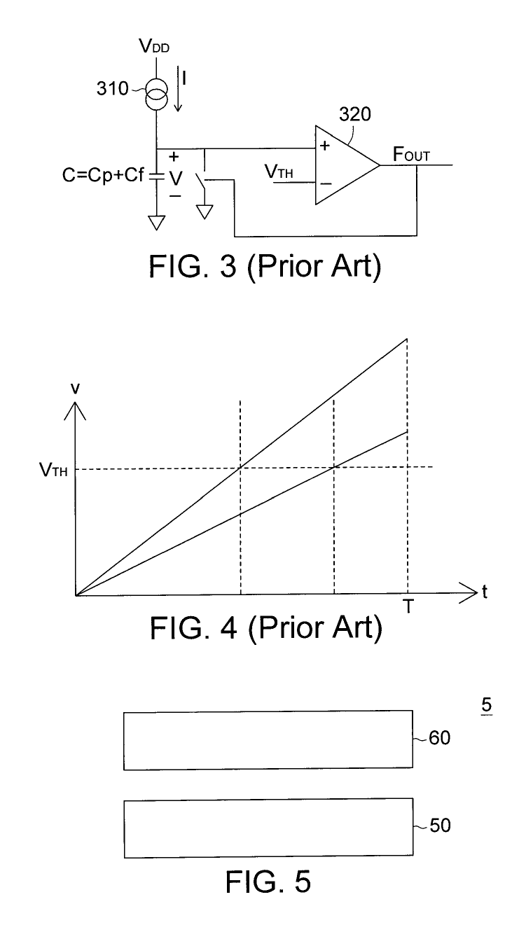

### DETAILED DESCRIPTION OF THE INVENTION

To increase the panel size and resolve the problem of insufficient scan time, a capacitive touch apparatus, a touch display and a driving method thereof are provided in the following embodiments. The capacitive touch apparatus comprises a plurality of electrodes and a plurality of integrators. The electrodes are respectively coupled to the integrators. Each integrator comprises an operational amplifier, a capacitor and a switch. The operational amplifier receives a reference voltage, which changes to a second level from a first level in a reset interval and changes to the first level from the second level in a sense interval which comes before the reset interval. The capacitor and the switch are coupled to the operational amplifier. The switch is turned on in the reset interval for connecting both terminals of the capacitor and is turned off in the sense interval.

A driving method of capacitive touch apparatus is used for driving the capacitive touch apparatus. The capacitive touch apparatus comprises a plurality of electrodes and a plurality of integrators. The electrodes are respectively coupled to the integrators. Each integrator comprises an operational amplifier, a capacitor and a switch. The driving method comprises steps of turning on the switch for connecting both terminals of the capacitor and changing the reference voltage changes to a second level from a first level in the reset interval; and turning off the switch and changing the reference voltage to the first level from the second level in the sense interval.

The touch display comprises a capacitive touch apparatus and a display layer. The capacitive touch apparatus comprises a touch layer and a plurality of integrators. The touch layer comprises a plurality of electrodes disposed above the display layer and respectively coupled to a plurality of integrators. Each integrator comprises an operational amplifier, a capacitor and a switch. The operational amplifier receives a reference voltage, which changes to a second level from a first level in a reset interval and changes to the first level from the second level in a sense interval which comes before the reset interval. The capacitor and the switch are coupled to the operational amplifier. The switch is turned on in the reset interval for short-circuiting the capacitor and is turned off in the sense interval.

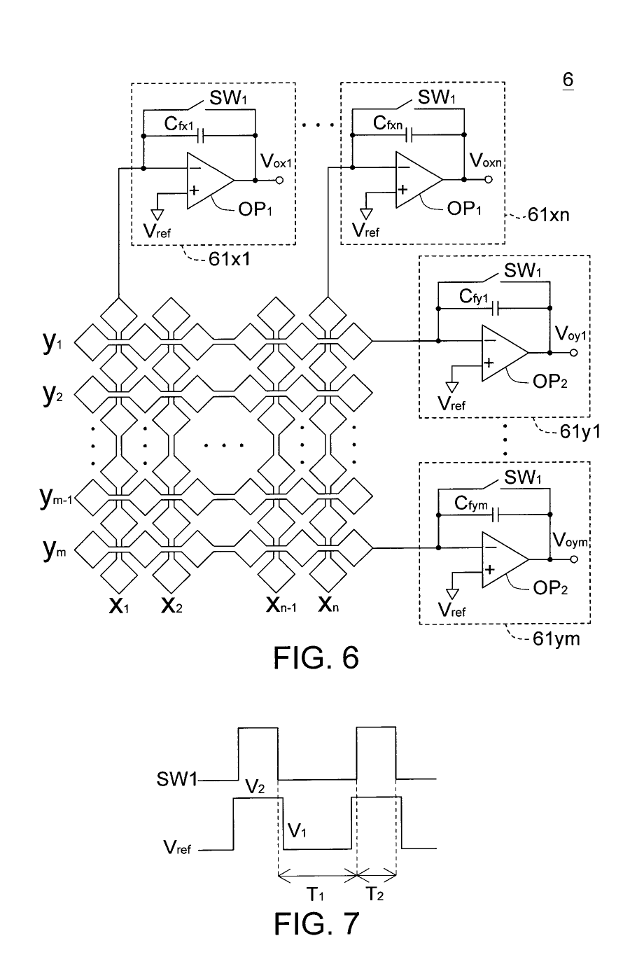

Referring to FIG. 5, FIG. 6 and FIG. 7. FIG. 5 shows a touch layer and a display layer. FIG. 6 shows a capacitive touch apparatus. FIG. 7 shows a timing sequence of a capacitive touch apparatus. The touch display 5 comprises a capacitive touch apparatus 6 and a display layer 50. The capacitive touch apparatus 6 comprises a touch layer 60, integrators 61x1˜61xn and integrators 61y1˜61ym. The touch layer 60 comprises row electrodes y₁˜yₘ and column electrodes x₁˜xₙ. The row electrodes y₁˜yₘ and the column electrodes x₁˜xₙ are interlaced. The row electrodes y_{1˜y}ₘ and the column electrodes x₁˜xₙ are disposed above the display layer 50. The row electrodes y₁˜yₘ and the column electrodes x₁˜xₙ are such as disposed on the glass substrate which has a color filter. The row electrodes y₁˜yₘ are respectively coupled to the integrators 61y1˜61ym. The column electrodes x₁˜xₙ are respectively coupled to the integrators 61x1˜61xn.

Each of the integrators 61x1˜61xn comprises an operational amplifier OP₁, a capacitor C_{fx} and a switch SW₁. Both terminals of the capacitor C_{fx} are respectively coupled to the inverse input terminal and the output terminal of the operational amplifier OP₁. Both terminals of the switch SW₁ are respectively coupled to the inverse input terminal and the output terminal of the operational amplifier OP₁. The non-inverse input terminal of the operational amplifier OP₁ receives a reference voltage V_{ref}. Each of the integrators 61y1˜61ym comprises an operational amplifier OP₂, a capacitor C_{fy} and a switch SW₁. Both terminals of the capacitor C_{fy} are respectively coupled to the inverse input terminal and the output terminal of the operational amplifier OP₂. Both terminals of the switch SW₁ are respectively coupled to the inverse input terminal and the output terminal of the operational amplifier OP₂. The non-inverse input terminal of the operational amplifier OP₂ receives a reference voltage V_{ref}.

The switch SW₁ is turned on for connecting both terminals of the capacitor C_{fx} in a reset interval T₁ and the reference voltage V_{ref} changes to a second level V₁ from a first level V₂ in a reset interval T₁. The second level V₁ is equal to a working voltage of the display layer 50 so as to further reduce the parasitic capacitance generated in the display layer 50. The charges on the integrators 61x1˜61xn and the integrators 61y1˜61ym are cleared in the reset interval T₁, so that the integrators 61x1˜61xn and the integrators 61y1˜61ym can perform sensing in the subsequent sense interval T₂.

In the sense interval T₂, the switch SW₁ is turned off and the reference voltage V_{ref} changes to the first level V₂ from the second level V₁. The capacitive touch apparatus 6 determines whether the capacitive touch apparatus 6 is touched by way of measuring the output voltages at the output terminals of the operational amplifiers OP₁ and OP₂.

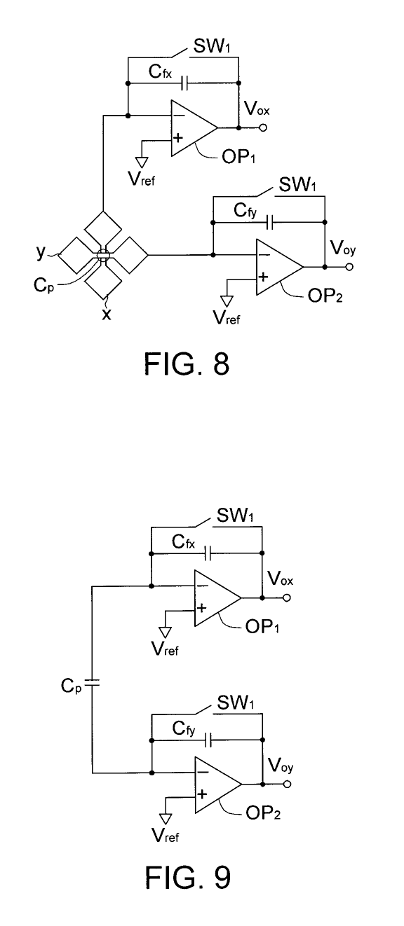

Referring to FIG. 8 and FIG. 9. FIG. 8 shows a capacitive touch apparatus having 1×1 resolution level and not being touched. FIG. 9 shows an equivalent circuit diagram of FIG. 8. A capacitor Cₚ is formed between the column electrode x and the row electrode y. In the reset interval T₁, the switch SW₁ is short-circuited. The output voltage Vₒₓ at the output terminal of the operational amplifier OP₁ is expressed as Vₒₓ=V_{ref}=V₁, and the output voltage V_{oy} at the output terminal of the operational amplifier OP₂ is expressed as V_{oy}=V_{ref}=V₁. Since the voltages at the inverse input terminals of the operational amplifiers OP₁ and OP₂ are both equal to the second level V₁, no charge is stored in the capacitor Cₚ.

Next, in the sense interval T₂, the switch SW₁ is open looped. The output voltage Vₒₓ at the output terminal of the operational amplifier OP₁ is expressed as Vₒₓ=V_{ref}=V₂, and the output voltage V_{oy} at the output terminal of the operational amplifier OP₂ is expressed as V_{oy}=V_{ref}=V₂. Since the voltages at the inverse input terminals of the operational amplifier OP₁ and OP₂ are both equal to the first level V₂, no charge is stored in the capacitor Cₚ.

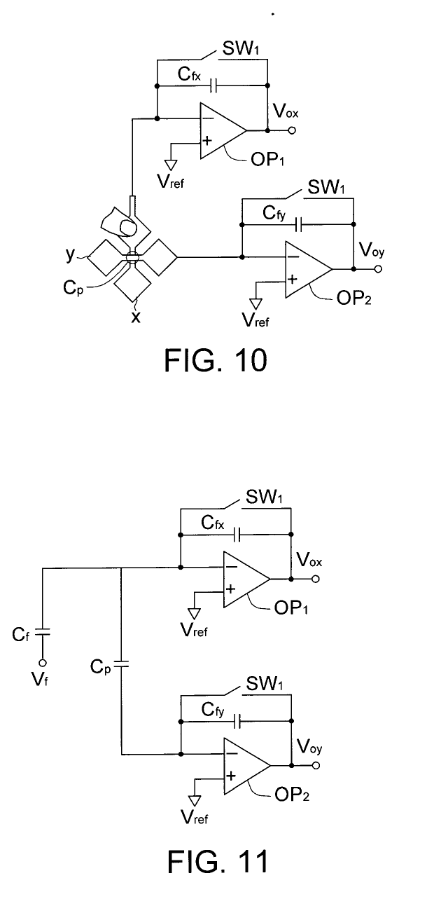

Referring to FIG. 10 and FIG. 11. FIG. 10 shows a capacitive touch apparatus having 1×1 resolution level and the column electrode x is being touched. FIG. 11 shows an equivalent circuit diagram of FIG. 10. A capacitor Cₚ is formed between the column electrode x and the row electrode y. When the user touches the capacitive touch apparatus, a sensing capacitor C_{f} is formed. One terminal of the sensing capacitor C_{f} is coupled to the capacitor Cₚ, and the potential at the other terminal of the sensing capacitor C_{f} is equal to the finger voltage V_{f}.

In the reset interval T₁, the switch SW₁ is short-circuited and the reference voltage V_{ref} changes to a second level V₁ from a first level V₂. The charge amounts on the capacitors Cₚ, C_{fx} and C_{fy} are all equal to 0. Thus, the total charges at the inverse input terminal of the operational amplifier OP₁ is expressed as C_{f} (V₁−V_{f}), and the output voltage Vₒₓ at the output terminal of the operational amplifier OP₂ is equal to the second level V₁. The total charge at the inverse input terminal of the operational amplifier OP₁ is equal to 0, and the output voltage V_{oy} at the output terminal of the operational amplifier OP₂ is equal to the second level V₁.

In the sense interval T₂, the switch SW₁ is open looped and the reference voltage V_{ref} changes to the first level V₂ from the second level V₁. Since the voltages at the inverse input terminals of the operational amplifiers OP₁ and OP₂ are both equal to the first level V₂, no charge is stored in the capacitor Cₚ. For the capacitors Cₚ, C_{fx} and C_{f} that are coupled to the inverse input terminal of the operational amplifier OP₁, the charges stored in the capacitor will be redistributed due to the change in the voltage. Since the elements coupled to the inverse input terminal of the operational amplifier OP₁ are all realized by capacitors, the charges cannot be moved, and the total charge of the capacitors Cₚ, C_{fx} and C_{f} when in the sense interval T₂ are the same with the total charge when the reference voltage V_{ref} is equal to level V₁. Thus, the output voltage of the operational amplifier OP₁ is expressed as

$${V}_{ox} = {V}_{2} + \frac{{C}_{f}}{{C}_{fx}} ( {V}_{2} - {V}_{1} ) .$$

Moreover, since the total charge of the capacitor Cₚ is 0, the charge of the capacitor C_{fy} is 0 as well. The output voltage V_{oy} of the operational amplifier OP₂ is equal to the first level V₂.

Thus, when the capacitive touch apparatus 6 is touched, the output voltage of the operational amplifier OP₁ is expressed as

$${V}_{ox} = {V}_{2} + \frac{{C}_{f}}{{C}_{fx}} ( {V}_{2} - {V}_{1} ) .$$

To the contrary, when the capacitive touch apparatus is not touched, the output voltage of the operational amplifier OP₁ is expressed as Vₒₓ=V₂.

Since the capacitive touch apparatus 6 detects the transfer amount of charges rather than the resistive-capacitive delay, and further eliminates the influence resulted by the parasitic capacitance, it can be used in large-scaled touch panel. In addition, the capacitive touch apparatus 6 does not scan all electrodes sequentially, instead, it can read all data during a touch frame, and hence the problem of insufficient scan time is solved.

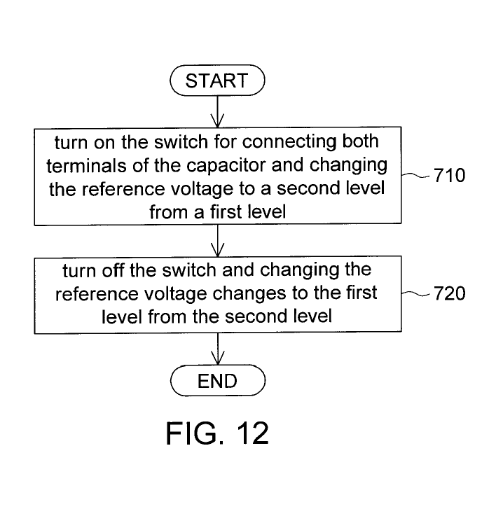

Referring to FIG. 12, a flowchart of a driving method according to an embodiment of the invention is shown. The driving method is used for driving the capacitive touch apparatus 6 of the touch display 5 and comprises the following steps: Firstly, the method begins at step 710, the switch SW₁ is turned on for connecting both terminals of the capacitors C_{fx} and C_{fy} and changing the reference voltage V_{ref} to a second level V₁ from a first level V₂ in the reset interval T₁. Next, the method proceeds to step 720, the switch SW₁ is turned off, and the reference voltage V_{ref} is changed to the first level V₂ from the second level V₁ in the sense interval T₂.

The capacitive touch apparatus, the touch display and the driving method thereof disclosed in the above embodiments of the invention have many advantages exemplified below:

Firstly, the touch panel size is increased.

Secondly, the problem of insufficient scan time is avoided.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A touch display, comprising:
a capacitive touch apparatus, comprising:
a touch layer, comprising:
a plurality of electrodes;
a plurality of integrators, wherein the electrodes are respectively coupled to the integrators each comprising:
an operational amplifier for receiving a reference voltage, which changes to a second level from a first level in a reset interval and changes to the first level from the second level in a sense interval after the reset interval;
a capacitor coupled to the operational amplifier;
a switch coupled to the operational amplifier, wherein the switch is turned on for short-circuiting the capacitor in the reset interval and is turned off in the sense interval; and
a display layer above which the electrodes are disposed.

2. The touch display according to claim 1, wherein the first level is larger than the second level.

3. The touch display according to claim 1, wherein the second level is equal to a working voltage of the display layer.

4. The touch display according to claim 1, wherein the operational amplifier comprises an inverse input terminal, a non-inverse input terminal and an output terminal, and the non-inverse input terminal receives a reference voltage.

5. The touch display according to claim 4, wherein both terminals of the capacitor are respectively coupled to the inverse input terminal and the output terminal.

6. The touch display according to claim 4, wherein both terminals of the switch are respectively coupled to the inverse input terminal and the output terminal.

7. The touch display according to claim 4, wherein the inverse input terminal is coupled to one of the electrodes.

8. The touch display according to claim 1, wherein the touch display further comprises a glass substrate on which the electrodes are disposed.

9. The touch display according to claim 1, wherein the electrodes comprises:
a plurality of first electrodes; and
a plurality of second electrodes interlaced with the first electrodes.

10. A driving method of touch display, wherein the touch display comprises a capacitive touch apparatus and a display layer, the capacitive touch apparatus comprises a plurality of electrodes and a plurality of integrators, the electrodes are respectively coupled to the integrators, the electrodes are disposed above the display layer, each integrator comprises an operational amplifier, a capacitor and a switch, and the driving method comprises:
turning on the switch for connecting both terminals of the capacitor and changing the reference voltage to a second level from a first level in a reset interval; and
turning off the switch and changing the reference voltage changes to the first level from the second level in a sense interval.

11. The driving method according to claim 10, wherein the first level is larger than the second level.

12. The driving method according to claim 10, wherein the second level is equal to of a working voltage the display layer.

13. The driving method according to claim 10, wherein the operational amplifier comprises an inverse input terminal, a non-inverse input terminal and an output terminal, and the non-inverse input terminal receives a reference voltage.

14. The driving method according to claim 13, wherein both terminals of the capacitor are respectively coupled to the inverse input terminal and the output terminal.

15. The driving method according to claim 13, wherein both terminals of the switch are respectively coupled to the inverse input terminal and the output terminal.

16. The driving method according to claim 13, wherein the inverse input terminal is coupled to one of the electrodes.

17. The driving method according to claim 10, wherein the electrodes are disposed on a glass substrate.

18. The driving method according to claim 10, wherein the electrodes comprise:
a plurality of first electrodes; and
a plurality of second electrodes interlaced with the first electrodes.
